(19) United States
(12) Patent Application Publication
(10) Pub. No.: US 2026/0356685 A1
(43) Pub. Date: Nov. 12, 2026

(54) DISPERSION METHOD FOR CERIUM OXIDE, AND CERIUM OXIDE DISPERSION

(71) Applicant: ANJI MICROELECTRONICS TECHNOLOGY (SHANGHAI) CO., LTD., Pudong New Area, Shanghai (CN)

(72) Inventors: Pengyu XU, Shanghai (CN); Yue CHEN, Shanghai (CN); Yinbin CHEN, Shanghai (CN); Shoutian LI, Shanghai (CN)

(21) Appl. No.: 19/137,608

(22) PCT Filed: Dec. 11, 2023
(86) PCT No.: PCT/CN2023/137952

§ 371 Date: Jun. 10, 2025

(30) Foreign Application Priority Data
Dec. 13, 2022 (CN) 202211595020.9

(51) Int. Cl. C01F 17/235; B01F 23/50; C01F 17/10; C09G 1/02; C09K 3/14

(52) U.S. Cl. CPC C01F 17/235; B01F 23/511; B01F 23/551; C01F 17/10; B01F 2215/0477; C09G 1/02; C09K 3/1409

(57) ABSTRACT

The present invention provides a method for dispersing cerium oxide and a cerium oxide dispersion solution. Specifically, the method for dispersing cerium oxide comprises: preparing a first dispersion solution using powdered cerium oxide; alternately performing high-speed shearing and ultrasonic mixing on the first dispersion solution to form a second dispersion solution; allowing the second dispersion solution to stand still and removing the precipitate. The cerium oxide dispersion solution obtained through the method used in the present invention has good stability.

### TECHNICAL FIELD

The present invention relates to the technical field of chemical raw materials, to a method for dispersing cerium oxide and a cerium oxide dispersion liquid.

### BACKGROUND

Cerium oxide has important application implications as abrasive particles in one commonly used chemical mechanical polishing solution. Cerium oxide polishing solutions have numerous advantages over silicon oxide polishing solutions. One can cite as follows, with properties of low solids content, high reactivity, high selectivity. Polishing solutions of cerium oxide are mainly currently used in STI, ILD fabrication in FEOL. Since cerium oxide polishing solution is used in STI, there are important requirements for scratching and the content of sodium ions in the CMP process. As such, there are important requirements for the original dispersion of cerium oxide. At the same time, the specific gravity of the cerium oxide is greater than water, so that the stability of the cerium oxide dispersion is crucial. As regards the requirements described above, it is possible to control by the dispersion process of the cerium oxide powder.

The stability of the dispersion of cerium oxide can be by controlling the pH and solids content of the dispersion. The content of metal ions can be controlled by not adding additional surfactant.

### DESCRIPTION

In order to overcome the poor stability and technical problems of cerium oxide dispersion in the prior art, the present invention provides a method for dispersing cerium oxide and a cerium oxide dispersion liquid.

In particular, the present invention provides a method for dispersing cerium oxide, comprising: configuring a first dispersion with powdered cerium oxide; subjecting the first dispersion to high shear and ultrasonic mixing treatment sequentially to form a second dispersion; standing the second dispersion to remove the precipitate.

Preferably, the solid content of the first dispersion liquid is 5 wt %-50 wt %.

Preferably, the solid content of the first dispersion liquid is 20 wt %-30 wt %, and the pH value of the first dispersion liquid is adjusted to 4.0-5.0.

Preferably, subjecting first dispersion to high shear treatment for 10-180 min.

Preferably, high shear treatment for 60-120 min.

Preferably, after allowing the second dispersion to stand for 1 h-36h, the precipitate is removed to obtain the dispersion product.

Preferably, after allowing the second dispersion to stand for 6 h-24h, the precipitate is removed to obtain the dispersion product.

In another aspect of the present invention, there is provided a cerium oxide dispersion made using any of the dispersion methods described above.

Using the dispersing method for cerium oxide in the present invention, it is possible to effectively improve the stability of the cerium oxide dispersion, and no additive leads to contamination of metal ions, facilitating subsequent use.

### EMBODIMENTS

Advantages of the invention are further elucidated below in connection with embodiments.

Embodiment 1: KOH or HNO₃ solution used as pH adjuster in this embodiment.

### Embodiment 1a

After mixing 100 g of cerium oxide particles and 900 g of deionized water, the pH was adjusted to 3 and dispersed with high shear for 60 minutes. After removing the bottom precipitate after standing for 12 h, a dispersion was obtained.

### Embodiment 1b

After mixing 100 g of cerium oxide particles and 900 g of deionized water, the pH was adjusted to 4.5 and dispersed with high shear for 60 minutes. After removing the bottom precipitate after standing for 12 h, a dispersion was obtained.

### Embodiment 1c

After mixing 100 g of cerium oxide particles and 900 g of deionized water, the pH was adjusted to 6 and dispersed by high shear for 60 minutes. After removing the bottom precipitate after standing for 12 h, a dispersion was obtained.

### Embodiment 1d

After mixing 100 g of cerium oxide particles and 900 g of deionized water, the pH was adjusted to 7 and dispersed by high shear for 60 minutes. After removing the bottom precipitate after standing for 12 h, a dispersion was obtained.

### Embodiment 1e

After mixing 100 g of cerium oxide particles and 900 g of deionized water, the pH was adjusted to 8 and dispersed with high shear for 60 minutes. After removing the bottom precipitate after standing for 12 h, a dispersion was obtained.

The potential at the surface of the cerium oxide particles in Embodiments 1a to 1e was tested using Malvern zeta potential, and data such as pH value, particle size, and solid content of the cerium oxide dispersions in Embodiments 1a to 1e were tested, and the test results are shown in Table 1.

TABLE 1
Test results of cerium oxide dispersion
solutions in Embodiments 1a to 1e

| Dispersion | Embodi- | Embodi- | Embodi- | Embodi- | Embodi- |
|---|---|---|---|---|---|
| liquid | ment 1a | ment 1b | ment 1c | ment 1d | ment 1e |
| pH | 3 | 4.5 | 6 | 7 | 8 |
| Zeta (mV) | 30.7 | 36.6 | 30.5 | 24.8 | 20.2 |
| Particle | 236.3 | 218.9 | 246.5 | 330.6 | Coagu- |
| size (nm) | | | | | lation |
| Particle size | 287.5 | 223.3 | 276.7 | 366.0 | Coagu- |
| after one | | | | | lation |
| week (nm) | | | | | |
| Designed | 10 | 10 | 10 | 10 | 10 |
| solid | | | | | |
| loading | | | | | |
| (wt %) | | | | | |
| Remained | 7.93 | 9.44 | 8.59 | 9.34 | Coagu- |
| solid | | | | | lation |
| loading | | | | | |
| (wt %) | | | | | |
| Dispersion | 79.3 | 94.4 | 85.9 | 93.4 | 0 |
| efficiency | | | | | |
| (%) | | | | | |

Wherein, Dispersion Efficiency=Remained solid loading/Designed solid loading*100%.

Based on the test results in Table 1, the effect of the pH value of the dispersion on the dispersion, it can be seen that when the cerium oxide dispersion pH=4.5 was adjusted, after 60 min of shearing, the particle size in the solution was the smallest and the absolute value of the zeta potential was the largest, the particle distribution was the most stable, and standing for 12 h, the bottom precipitation amount removed was the least.

### Embodiment 2

When the powder is dispersed into the aqueous solution, the solid content of the particles varies, and the gaps between the solid particles also differ. This, in turn, affects the stability of the solid particles in the aqueous solution. Therefore, the solid content of the dispersion solution has a direct impact on the yield of the dispersion solution.

### Embodiment 2a

After mixing 50 g of cerium oxide particles, 950 g of deionized water, the pH was adjusted to 4.5 and dispersed by high shear for 60 minutes. After removing the bottom precipitate after standing for 12 h, a dispersion was obtained.

### Embodiment 2b

After mixing 100 g of cerium oxide particles and 900 g of deionized water, the pH was adjusted to 4.5 and dispersed with high shear for 60 minutes. After removing the bottom precipitate after standing for 12 h, a dispersion was obtained.

### Embodiment 2c

After mixing 200 g of cerium oxide particles, 800 g of deionized water, the pH was adjusted to 4.5 and dispersed by high shear for 60 minutes. After removing the bottom precipitate after standing for 12 h, a dispersion was obtained.

### Embodiment 2d

After mixing 300 g of cerium oxide particles, 700 g of deionized water, the pH was adjusted to 4.5 and dispersed by high shear for 60 minutes. After removing the bottom precipitate after standing for 12 h, a dispersion was obtained.

### Embodiment 2e

After mixing 400 g of cerium oxide particles and 600 g of deionized water, the pH was adjusted to 4.5 and dispersed by high shear for 60 minutes. After removing the bottom precipitate after standing for 12 h, a dispersion was obtained.

TABLE 2
Test results of Embodiment 2a-Example
2e cerium oxide dispersions

| Dispersion | Embodi- | Embodi- | Embodi- | Embodi- | Embodi- |
|---|---|---|---|---|---|
| liquid | ment 2a | ment 2b | ment 2c | ment 2d | ment 2e |
| Solid content | 5% | 10% | 20% | 30% | 40% |
| Designed | 5 | 10 | 20 | 30 | 40 |
| solid | | | | | |
| loading | | | | | |
| (wt %) | | | | | |
| Remained | 4.82 | 9.44 | 19.21 | 28.82 | 35.95 |
| solid | | | | | |
| loading | | | | | |
| (wt %) | | | | | |
| Dispersion | 96.4 | 94.4 | 96.1 | 96.1 | 89.8 |
| efficiency | | | | | |
| (%) | | | | | |
| Zeta (mV) | 37.8 | 37.2 | 43.2 | 37.8 | 46.4 |
| Particle | 224.8 | 218.9 | 220.5 | 216.9 | 224.4 |
| size (nm) | | | | | |
| Particle size | 219.5 | 223.3 | 217.3 | 219.2 | 214.5 |
| after one | | | | | |
| week (nm) | | | | | |

As can be seen from the results of Table 2, the best dispersion efficiency can be achieved with a solid content between 20% and 30%. Among them, the particle sizes of Embodiments 2a, 2c, 2e became smaller after one week, fall within the test error range, and were not trend representative.

### Embodiment 3

### Embodiment 3a

After mixing 100 g of cerium oxide particles and 900 g of deionized water, the pH was adjusted to 4.5 and dispersed with high shear for 60 minutes. After removing the bottom precipitate after standing for 12 h, a dispersion was obtained.

### Embodiment 3b

After mixing 100 g of cerium oxide particles and 900 g of deionized water, the pH was adjusted to 4.5 and ultrasonically dispersed for 60 minutes. After removing the bottom precipitate after standing for 12 h, a dispersion was obtained.

### Embodiment 3c

After mixing 100 g of cerium oxide particles and 900 g of deionized water, the pH was adjusted to 4.5 and dispersed with high shear for 30 minutes, followed by ultrasonic dispersion for 30 minutes. After removing the bottom precipitate after standing for 12 h, a dispersion was obtained.

TABLE 3
Test results of Embodiment 3a-Example
3c cerium oxide dispersions

| Dispersion | Embodi- | Embodi- | Embodi- |
|---|---|---|---|
| liquid | ment 3a | ment 3b | ment 3c |
| Operation | Shear 60 min | Ultrasonic | Shear 30 min + |
| method | | 60 min | Ultrasonic 30 min |
| Zeta (mV) | 37.0 | 46.5 | 34.1 |
| Particle | 216.7 | 271.3 | 237.1 |
| size (nm) | | | |
| Particle size | 218.9 | 193.4 | 106.1 |
| after one | | | |
| week (nm) | | | |
| Designed | 30 | 30 | 30 |
| solid | | | |
| loading | | | |
| (wt %) | | | |
| Remained | 28.82 | 27.11 | 28.26 |
| solid | | | |
| loading | | | |
| (wt %) | | | |
| Dispersion | 96.1 | 90.4 | 94.2 |
| efficiency | | | |
| (%) | | | |

The results shown in Table 3 show that the dispersion effect in Embodiments 3b and 3c was less than ideal due to the operation method of ultrasound or shear plus ultrasound, and after one week, the particle size became significantly smaller, indicating that the large particles had developed sedimentation phenomena. It follows that ultrasonic dispersion is less efficient for powder dispersion than shear dispersion.

And the shear time directly affects the extent of its dispersion: if the shear time is too short, the dispersion of the powder is not complete, resulting in an oversized powder particle, a large number of agglomerated particles, resulting in an unstable dispersion thereof, and a low yield. Too long a shear time leads to too high a temperature of the solution, possibly causing its instability and resulting in inefficiency. So, a suitable shear time can be efficient to obtain a stable dispersion.

### Embodiment 4a

After mixing 300 g of cerium oxide particles and 700 g of deionized water, the pH was adjusted to 4.5 and dispersed by high shear for 10 minutes. After removing the bottom precipitate after standing for 12 h, a dispersion was obtained.

### Embodiment 4b

After mixing 300 g cerium oxide particles, 700 g deionized water, the pH was adjusted to 4.5 and ultrasonically dispersed for 30 minutes. After removing the bottom precipitate after standing for 12 h, a dispersion was obtained.

### Embodiment 4c

After mixing 300 g of cerium oxide particles, 700 g of deionized water, the pH was adjusted to 4.5 and dispersed by high shear for 60 minutes. After removing the bottom precipitate after standing for 12 h, a dispersion was obtained.

### Embodiment 4e

After mixing 300 g of cerium oxide particles, 700 g of deionized water, the pH was adjusted to 4.5 and dispersed by high shear for 90 minutes. After removing the bottom precipitate after standing for 12 h, a dispersion was obtained.

TABLE 4
Test results of Embodiment 4a-Example
4e cerium oxide dispersions

| Dispersion | Embodi- | Embodi- | Embodi- | Embodi- |
|---|---|---|---|---|
| liquid | ment 4a | ment 4b | ment 4c | ment 4e |
| High-speed | 10 | 30 | 60 | 90 |
| shearing time | | | | |
| (min) | | | | |
| Zeta (mV) | 20.0 | 35.3 | 37.0 | 37.8 |
| Particle | 242.7 | 224.4 | 216.7 | 216.9 |
| size (nm) | | | | |
| Particle size | Coagu- | Coagu- | 218.9 | 219.2 |
| after one | lation | lation | | |
| week (nm) | | | | |
| Designed | 30 | 30 | 30 | 30 |
| solid | | | | |
| loading | | | | |
| (wt %) | | | | |
| Remained | N.A. | N.A. | 28.82 | 28.82 |
| solid | | | | |
| loading | | | | |
| (wt %) | | | | |
| Dispersion | 0 | 0 | 96.1 | 96.1 |
| efficiency | | | | |
| (%) | | | | |

As can be seen from the results of Table 4, shear times greater than 60 min can achieve uniform dispersion, as well as guarantee stability of the dispersion.

The dispersion forms a uniform, stable dispersion after shear dispersion. The presence of large particles in the polishing solution can increase scratching during polishing. Therefore, to further purify the purity of the dispersion and remove large particles as well as micro-agglomerated particles, the method of static sedimentation can be adopted. By allowing it to stand and settle for a certain period and then removing the settled substances at the bottom to achieve the removal of large particles. By controlling the duration of the standing and settling, a balance needs to be found between the removal of large particles and the loss of solid content.

### Embodiment 5

### Embodiment 5a

After mixing 300 g of cerium oxide particles, 700 g of deionized water, the pH was adjusted to 4.5 and dispersed by high shear for 60 minutes. After removing the bottom precipitate after 1 h standing, a dispersion was obtained.

### Embodiment 5b

After mixing 300 g of cerium oxide particles, 700 g of deionized water, the pH was adjusted to 4.5 and dispersed by high shear for 60 minutes. After removing the bottom precipitate after standing for 6h, a dispersion was obtained.

### Embodiment 5c

After mixing 300 g of cerium oxide particles, 700 g of deionized water, the pH was adjusted to 4.5 and dispersed by high shear for 60 minutes. After removing the bottom precipitate after standing for 12 h, a dispersion was obtained.

### Embodiment 5d

After mixing 300 g of cerium oxide particles, 700 g of deionized water, the pH was adjusted to 4.5 and dispersed by high shear for 60 minutes. After removing the bottom precipitate after standing for 24 h, a dispersion was obtained.

### Embodiment 5e

After mixing 300 g of cerium oxide particles, 700 g of deionized water, the pH was adjusted to 4.5 and dispersed by high shear for 60 minutes.

After removing the bottom precipitate after standing for 36h, a dispersion was obtained.

TABLE 5
Test results of Embodiment 5a-Example
5e cerium oxide dispersions

| Dispersion | Embodi- | Embodi- | Embodi- | Embodi- | Embodi- |
|---|---|---|---|---|---|
| liquid | ment 5a | ment 5b | ment 5c | ment 5d | ment 5e |
| Standing | 1 | 6 | 12 | 24 | 36 |
| time (h) | | | | | |
| Zeta (mV) | 39.7 | 41.0 | 38.9 | 37.2 | 37.8 |
| Particle | 219.1 | 217.1 | 218.7 | 219.6 | 219.2 |
| size (nm) | | | | | |
| Particle size | 220.1 | 218.3 | 220.1 | 223.4 | 221.0 |
| after one | | | | | |
| week (nm) | | | | | |
| Designed | 30 | 30 | 30 | 30 | 30 |
| solid | | | | | |
| loading | | | | | |
| (wt %) | | | | | |
| Remained | 29.95 | 29.28 | 29.03 | 28.83 | 28.82 |
| solid | | | | | |
| loading | | | | | |
| (wt %) | | | | | |
| Dispersion | 99.8 | 97.6 | 96.7 | 96.1 | 96.1 |
| efficiency | | | | | |
| (%) | | | | | |

From the test results in Table 5, after high-speed shear dispersion, through sedimentation over different periods of time, it was found that after 12 hours, the amount of sedimented particles significantly decreased, indicating that in the first 12 hours, the large particles (those with higher density) quickly settled down. However, after 12 hours, the amount of sediment obtained through sedimentation showed almost no change. Therefore, after 12 hours of sedimentation, the large particles that settled quickly can basically be removed. By removing the large, settled particles at the bottom, the defect rate in the subsequent polishing process can be effectively reduced, thereby improving the product yield.

Although the above specific embodiments of the present invention have been described in detail, they are only examples, and the present disclosure is limited to the embodiments described above. For those skilled in the art, any equivalent modification and substitution to the present invention is also covered in the present invention. Therefore, all these equivalent changes and modifications made without departing from the spirit and scope of the invention should be covered within the scope of the present invention.

1. A method for dispersing cerium oxide, characterized in that, comprising:
configuring a first dispersion with powdered cerium oxide; subjecting the first dispersion to alternating high shear and ultrasonic mixing treatments to form a second dispersion; the second dispersion was allowed to stand to remove the precipitate.

2. The method for dispersing cerium oxide according to claim 1, characterized in that the solid content of the first dispersion is between 5 wt % and 50 wt %.

3. The method for dispersing cerium oxide according to claim 2, characterized in that the solid content of said first dispersion is between 20 wt % and 30 wt % and the pH of said first dispersion is adjusted to 4.0-5.0.

4. The method for dispersing cerium oxide according to claim 1, characterized in that said first dispersion is subjected to high shear treatment for 10-180 min.

5. The method for dispersing cerium oxide according to claim 4, characterized in that high shear treatment is carried out for 60 to 120 min.

6. The method for dispersing cerium oxide according to claim 1, characterized in that after allowing the second dispersion to stand for 1 h-36h, the precipitate is removed to obtain the dispersion product.

7. The method for dispersing cerium oxide according to claim 6, characterized in that after allowing the second dispersion to stand for 6 h-24h, the precipitate is removed to obtain the dispersion product.

8. A cerium oxide dispersion liquid made by using the dispersion method of claim 1.
